(19) United States
(12) Patent Application Publication
(10) Pub. No.: US 2004/0223728 A1
(43) Pub. Date: Nov. 11, 2004

(54) Method and apparatus for determining entry points

(75) Inventor: Bum-sik Yoon, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/838,201

(22) Filed: May 5, 2004

(30) Foreign Application Priority Data
May 6, 2003 (KR) 2003-28631

(51) Int. Cl. H04N 5/76; H04N 5/781

(52) U.S. Cl. 386/46; 386/125

(57) ABSTRACT

A method of determining entry points, the method including: shifting N bit data stored in an N bit shift register by n bits when n<N, incrementing a shift counter, and inputting an input data packet to the shift register by n bits; determining whether the N bit data stored in the shift register corresponds with a predetermined start code; identifying a data packet having a head of the predetermined start code by referring to the shift counter and/or a data packet information list that has been previously stored when the N bit data stored in the shift register corresponds with the predetermined start code; and designating the data packet having the head of the predetermined start code as an entry point, wherein the data packet information list contains data length info of each previous input data packet.

### CROSS-REFERENCE TO RELATED APPLICATION

This application claims the priority of Korean Patent Application No. 2003-28631, filed on May 6, 2003, in the Korean Intellectual Property Office, the disclosure of which is incorporated herein by reference.

### BACKGROUND OF THE INVENTION

1. Field of the Invention

The present invention relates to a method and apparatus for determining entry points, and more particularly, to a method and apparatus for determining locations of data packets corresponding to entry points.

2. Description of the Related Art

As digital broadcasting becomes commercially available, digital video recorders for storing and reproducing digital broadcasting contents have increased in use.

The digital video recorders receive and store digital broadcasting signals. These signals are compressed according to a predetermined compression standard, for example, moving picture expert group—phase 2 (MPEG-2). Digital video recorders also decode and reproduce the stored digital broadcasting data on display devices, such as television or monitor sets, according to a user request

According to a conventional digital video recorder, digital data streams are received and stored in a compressed format. Simultaneously, in order to facilitate functions of data editing or trick-play such as a random access and a fast forward, a plurality of entry points are detected from the digital data streams and then indexed before storing them.

The video data compressed according to the MPEG-2 standard have a hierarchy comprising a sequence layer, a group of picture (GOP) layer, a picture layer, and so forth. Before transmitting the compressed video or audio data, the data is segmented into a predetermined length of data packets and then multiplexed.

The functions of the random access and the trick-play are implemented on the basis of a predetermined data unit length such as a sequence, a GOP, or a picture. The data unit length for the random access or the trick-play depends on a data compression standard or how the digital video recorder is manufactured

The entry point refers to a location of a data packet containing a head of a start code having a predetermined data unit length selected for the random access and the trick-play. The head of the start code is a segment containing a first bit of the start code.

According to a conventional MPEG-2 standard, in order to detect the location of a transport packet corresponding to an entry point from a received transport packet stream, an elementary stream containing video or audio data is extracted from the transport packet stream composed of successive transport packets and then buffered. Subsequently, the start code having a predetermined data unit length of, for example, a sequence, is detected. After detecting the start code, the location of the transport packet containing the head of the start code should be traced. Therefore, the entry point detection according to the conventional art is very complicated and time consuming. Also, a buffering memory for the entry point detection is provided in the digital video recorder, thereby increasing hardware complexity and manufacturing cost.

### SUMMARY OF THE INVENTION

The present invention provides a method of and an apparatus for determining entry points, wherein detecting locations of data packets corresponding to the entry points is much simpler and hardware for the entry point detection is less expensive.

According to an aspect of the present invention, there is provided a method of determining entry points, the method including: shifting N bit data stored in an N bit shift register by n bits (n<N), incrementing a shift counter C, and inputting an input data packet to the shift register by n bits; determining whether or not the N bit data stored in the shift register corresponds with a predetermined start code; identifying a data packet containing a head of the predetermined start code by referring to the shift counter C and/or a data packet information list that has been previously stored if the N bit data stored in the shift register is determined to correspond with the predetermined start code; and designating the data packet containing the head of the predetermined start code as an entry point, wherein the data packet information list contains data length information of each previous input data packet.

According to another aspect of the present invention, there is provided an apparatus for determining entry points, the apparatus including: a shift register which stores N bit data; a data packet information list storing unit which stores a data packet information list containing data length information of each previous input data packet; and a control unit which controls operations of shifting N bit data stored in the shift register by n bits (n<N), incrementing a shift counter C, inputting an input data packet into the shift register by n bits, identifying a data packet containing a head of a predetermined start code by referring to the shift counter C and/or the data packet information list stored in the data packet information list storing unit if the N bit data stored in the shift register corresponds with a predetermined start code, and designating the input data packet as an entry point.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments taken in conjunction with the accompanying drawings in which:

FIG. 1A is a packet diagram showing a packetized elementary stream generated according to the MPEG-2 standard;

FIG. 1B is a packet diagram showing a transport stream generated according to the MPEG-2 standard;

FIG. 2 is a block diagram of an apparatus for determining entry points according to an embodiment of the invention.

FIG. 3 is a block diagram of the construction of the start code detection unit shown in FIG. 2;

FIG. 4 is a flowchart of a method of determining entry points according to the embodiment of the invention;

FIG. 5 is a flowchart of operation 600 shown in FIG. 4;

FIG. 6 is a flowchart of operation 800 shown in FIG. 4;

FIG. 7 is a schematic diagram of video data contained in a plurality of input packets;

FIG. 8 is a table of a packet information list;

FIGS. 9A-9C are schematic diagrams of a shift operation for the data bits stored in the shift register; FIG. 10 is a table of the packet information list that has been updated; and

FIG. 11 is a table of the entry point list that has been updated.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

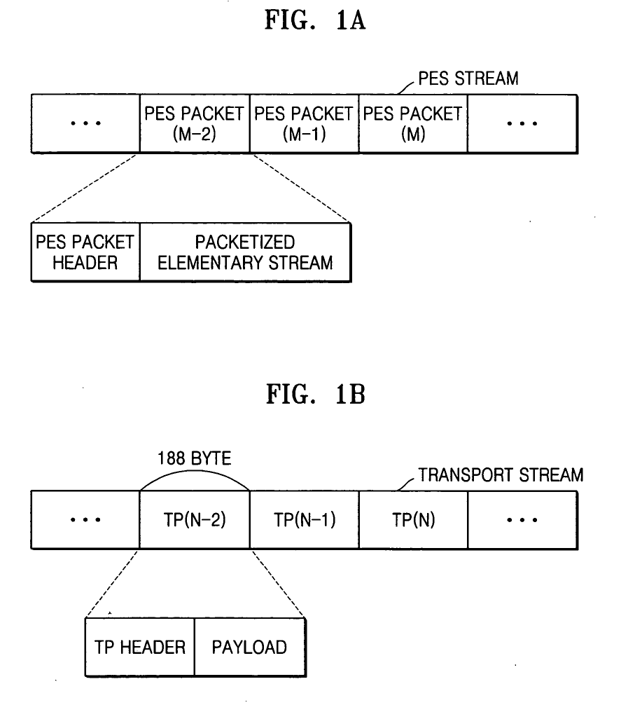

FIG. 1A is a packet diagram showing a packetized elementary stream (PES) generated according to the MPEG-2 standard. The PES is composed of a plurality of PES packets. Each PES packet includes a PES packet header and a PES packet payload. The PES packets are generated by segmenting an elementary stream, which contains successive video or audio data bits compressed according to the MPEG-2 standard, into a predetermined length of bits.

FIG. 1B is a packet diagram showing a transport stream generated according to the MPEG-2 standard. The transport stream includes a plurality of transport packets. Each transport packet has a length of 188 bytes and includes a transport packet header and a transport packet payload corresponding to the data field of the transport packet. The transport packets are generated by segmenting the PES packet payload into a predetermined length of bits and adding the transport packet header to each segment.

According to the present aspect, the apparatus for determining entry points receives the transport stream generated by compressing and multiplexing data according to the MPEG-2 standard as described above. The apparatus for determining entry points detects a predetermined bit of start code contained in one transport packet or overlapped across two or more transport packets among successive transport packets of the received transport stream, and then determines an entry point, which is the location of the transport packet having the head of the start code.

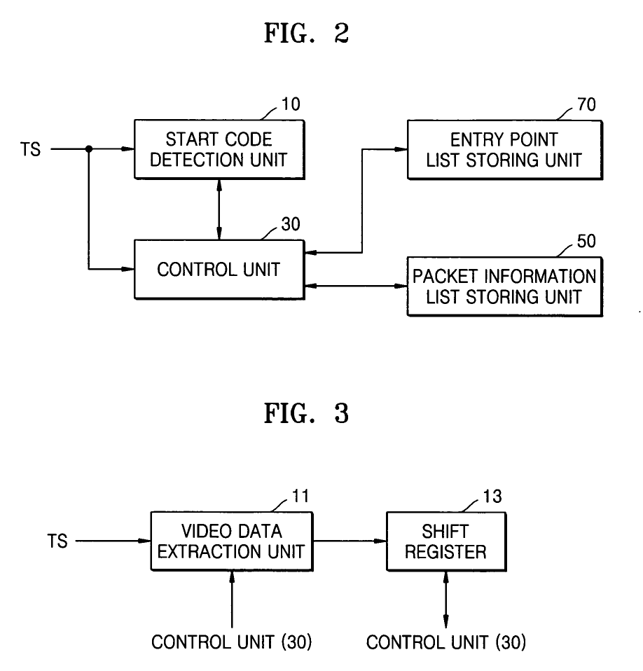

FIG. 2 is a block diagram showing an apparatus for determining entry points according to the present invention. The apparatus for determining entry points comprises a start code detection unit 10, a control unit 30, a packet information list storing unit 50, and an entry point list storing unit 70.

The start code detection unit 10 receives the transport stream including the successive transport packets and then detects a predetermined start code, under control of the control unit 30. The start code is a sequence start code having, for example, four bytes “00 00 01 XX” in hexadecimal according to the MPEG-2 standard. However, it is understood that the start code may comprise a group of picture (GOP) start code, a picture start code, and so forth. Hereinafter, a packet refers to the transport packet.

FIG. 3 is a block diagram showing the construction of the start code detection unit 10. The start code detection unit 10 comprises a video data extraction unit 11 and a shift register 13.

If the input packet is a video packet, the video data extraction unit 11 extracts video data from the video packet under control of the control unit 30. The extracted video data are sequentially provided to a shift register 13 by a predetermined length of bits.

The shift register 13 is organized to store a length of 4 bytes, i.e., 32 bits, corresponding to the sequence start code. In the shift register 13, one byte of the stored data bits is shifted in synchronization with a clock signal, and then one byte of the video data is input from the video data extraction unit 11.

The control unit 30 receives the transport stream having successive packets and controls the operation of determining entry points.

More specifically, when a packet is input, the control unit 30 detects a PID (packet identification) code included in the header of the packet to identify the type of the packet and the length of the data contained in the packet, and then compares the 4 byte data stored in the shift register 13 with the sequence start code previously stored in a register (not shown) of the control unit 30 to detect the start code. When the start code is detected, the control unit 30 identifies the location of the packet corresponding to an entry point by referring to a packet information list stored in a packet information list storing unit 50, and then updates the packet information list and an entry point list.

The packet information list storing unit 50 stores a packet information list having data length information of each previous input packet. The packet information list is updated under control of the control unit 30.

The entry point list storing unit 70 stores an entry point list having the location information of the packets corresponding to entry points. The entry point list is updated under control of the control unit 30 when each new entry point is determined.

The operations involved in determining the entry point according to the present invention is described in detail below based on the previously discussed construction of the apparatus for determining entry points.

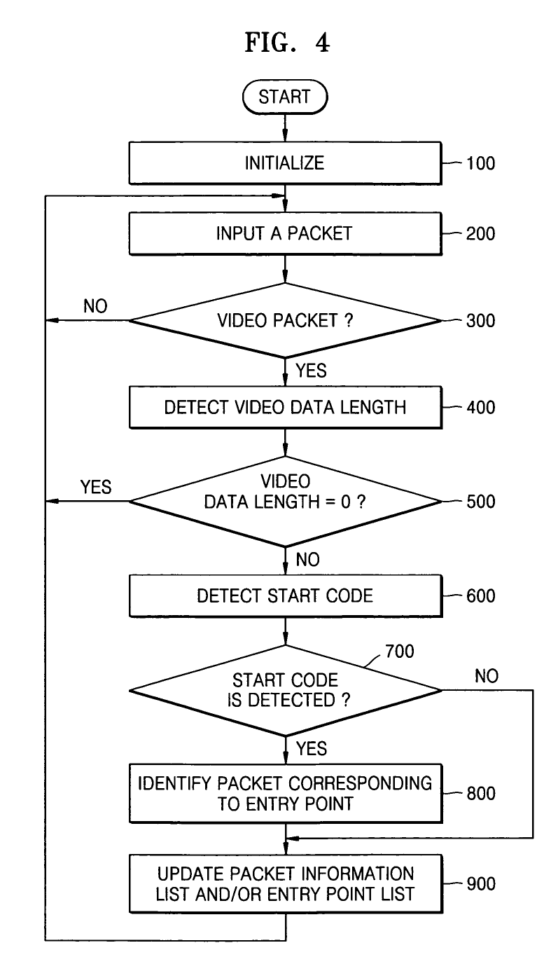

FIG. 4 is a flowchart showing a method of determining entry points according to the invention.

First, before determining an entry point, the apparatus for determining entry points is initialized (operation 100). All bits in the 32 bit shift register 13 are initialized to binary “1”. Variables such as a packet index variable for indexing the location of the packet in the packet information list are initialized to “0”.

When a packet is input (operation 200), the control unit 30 detects the PID code contained in the packet header to determine whether or not the input packet is a video packet (operation 300). Since the start code to be detected in the present embodiment is a sequence start code of video data, there is no need to proceed if the input packet is an audio packet.

If the input packet is a video packet, the control unit 30 detects the length of the video data contained in the packet (operation 400). The video data corresponds to the packetized elementary stream except for all PES packet headers as shown in FIG. 1A. The length of the video data is the number of data bytes less the packet headers and the PES packet headers.

If the length of the video data is detected to be zero, there is no need to proceed because there is no video data. Therefore, the operation 200] control unit waits for a new packet to be inputted (operation 200).

When the length of the video data is not zero, the start code detection is started because video data is in the packet (operation 600).

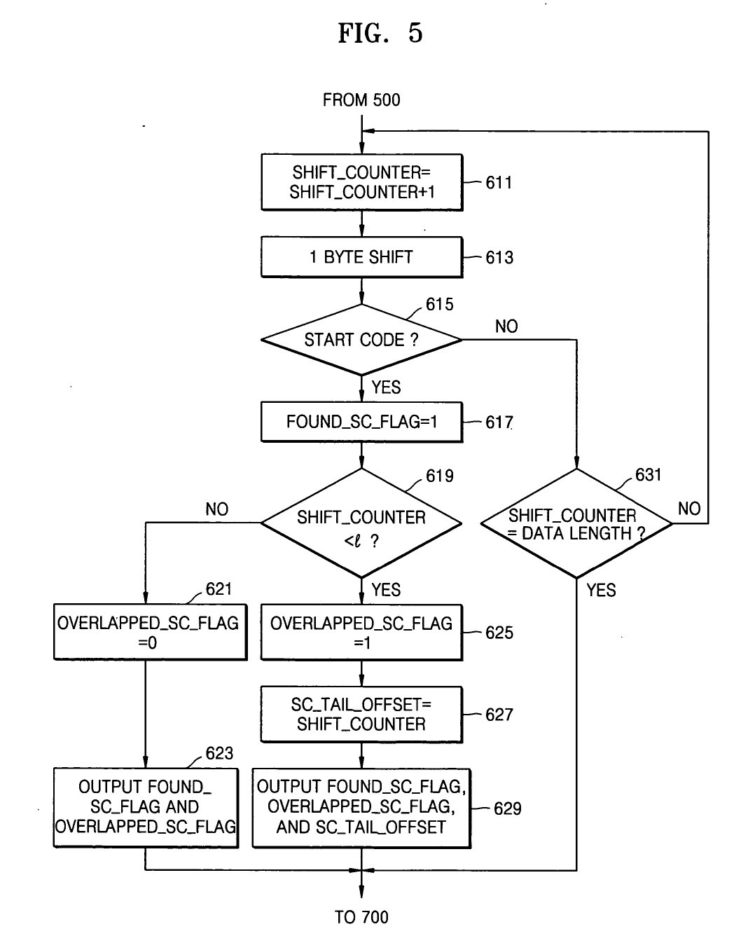

FIG. 5 is a flowchart showing the operation 600 shown in FIG. 4 in detail.

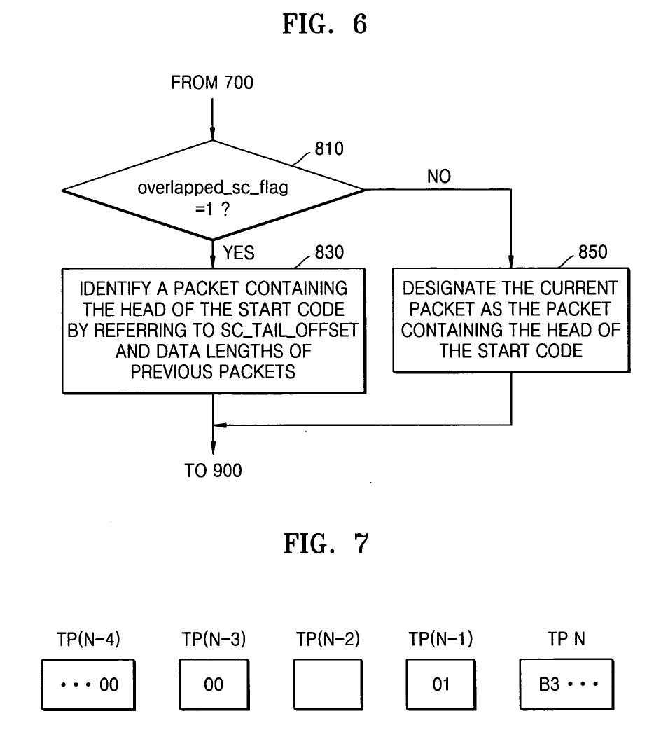

The start code detection procedure shown in FIG. 5 will be described in detail with reference to FIGS. 6 through 9C.

FIG. 7 is a schematic diagram showing an example of the video data contained in each packet. The video data contained in the video packets TP(N-4) through TP(N) are expressed in hexadecimal. TP(N) is a current input video packet. TP(N-4) through TP(N-1) are previous video packets.

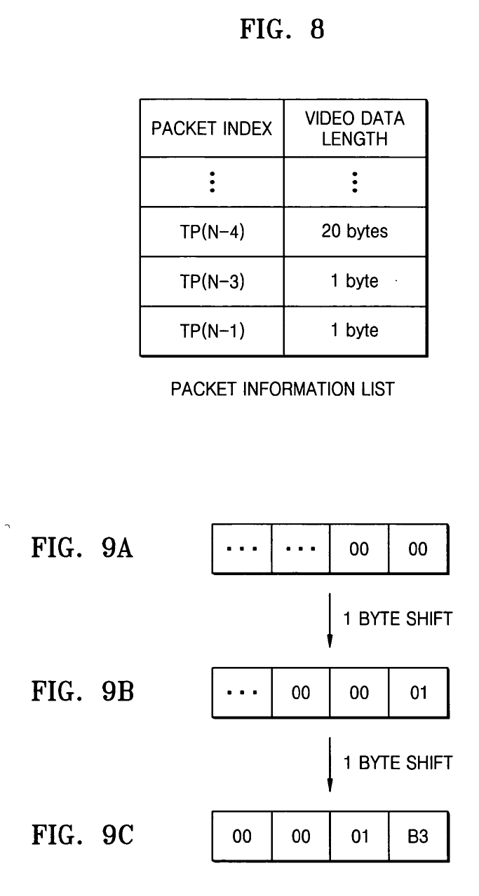

FIG. 8 is a table showing a packet information list having video data length information of the previous video packets such as TP(N-4) through TP(N-1). The packet information list can be used to identify the location of the packet having the start code when the start code is overlapped across at least two packets.

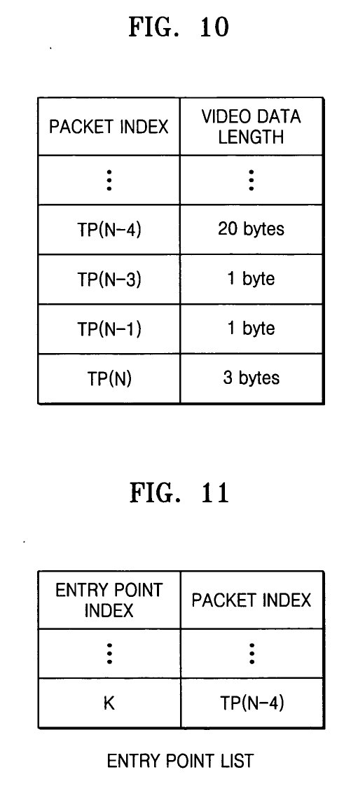

FIGS. 9A-9C are schematic diagrams showing an operation of shifting the data bits stored in the shift register 13 by one byte.

Referring to FIG. 9(A), the rightmost two byte locations of the 4-byte shift register 13 are filled with the video data “00” of TP(N-4) and the video data “00” of TP(N-3) shown in FIG. 7.

Referring to FIG. 9(B), the data stored in the shift register 13 shown in FIG. 9(A) are left-shifted by one byte, and the video data “01” of TP(N-1) shown in FIG. 7 is input and fills the rightmost byte location. Meanwhile, TP(N-1) has no video data and is not used for the start code detection as a result of the operation 500.

When the current packet TP(N) is input to the control unit 30 and the start code detection unit 10 in the state that the shift register 13 is filled with the data as shown in FIG. 9(C), the operations shown in FIG. 5 are accomplished.

As shown in FIG. 5, the control unit 30 increments shift_counter, which is one of the variables stored in the control unit 30 (Operation 611). The variable shift_counter is initialized to “0” in the operation 100 and reset to “0” again when the start code detection operations are completed with respect to all the video data contained in the previous packets. Since the first byte of the current packet TP(N) is input to the shift register 13, the value of shift_counter is changed from “0” to “1”.

The data stored in the shift register 13, as shown in FIG. 9(A), are left-shifted by one byte, and then the video data TP(N) is input from the video data extraction unit 11 to the shift register 14 (operation 613) by one byte. FIG. 9(C) shows the data stored in the shift register 13 when the one byte of the video data TP(N), for example, hexadecimal “B3”, is input to the shift register 14.

The control unit 30 compares the four-byte data stored in the shift register 13 with a sequence start code “00 00 01 XX” stored in a register (not shown) of the control unit 30 to determine whether or not the data corresponds with the start code (operation 615). Since the four-byte data stored in the shift register 13, as shown in FIG. 9(C), corresponds with the sequence start code, the control unit 30 determines that the four-byte data stored in the shift register 13 is the start code, and outputs a flag found sc flag designating the start code detection status as binary “1” (operation 617). The value “1” of found_sc_flag indicates that the start code is detected.

The control unit 30 determines whether the value of shift_counter is smaller or larger than a predetermined number “▾” (operation 619). The number “▾” is set to “4” in the present embodiment. For this reason, the value of shift_counter smaller than “4” indicates that the current input packet does not contain the entire start code but only a part, i.e., tail of the start code. The tail of the start code is the portion having the last bit of the start code.

In other words, the operation 619 is to determine whether or not the start code is overlapped across two packets.

If the value of shift_counter is not smaller than, i.e., equal to, “4” as a result of the operation 619, a flag overlapped_sc_flag designating whether or not the detected start code is overlapped across at least two packets is set to binary “0” and then output (operation 621). The value of overlapped_sc_flag set to binary “0” indicates that the start code is not overlapped across at least two packets but the entire start code is included in the current input packet TP(N).

The control unit 30 outputs the values of found_sc_flag set to binary “1” and overlapped_sc_flag set to binary “0” (operation 623).

On the other hand, if the value of shift_counter is smaller than “4”, the value of overlapped_sc_flag is set to binary “1” and then output (operation 625). The value of overlapped_sc_flag set to binary “1” indicates that the start code is overlapped across at least two packets.

The control unit 30 substitutes the value of a variable sc_tail_offset for the value of shift_counter set to “1” (operation 627). The value of the variable sc_tail_offset is used to determine an entry point in the subsequent procedures.

The control unit 30 outputs the variables of found_sc_flag set to binary “1”, overlapped_sc_flag set to binary “1”, and sc_tail_offset set to “1” (operation 629).

As a result of the operation 615, if the 4-byte data stored in the shift register 13 does not correspond with the start code, the control unit 30 determines whether the value of shift_counter is the same as the length of the data contained in the current input packet TP(N) (operation 631). The value of shift counter reflects the number of bytes input to the shift register 13 among the data contained in the current input packet TP(N).

If the value of shift_counter is not equal to the length of the data contained in the current input packet TP(N), then more data should be provided from the current input packet TP(N) to the shift register 13 until the start code is detected. As a result, operations 611 through 615 are repeated.

After completing the start code detection as a result of the operation 600, the control unit 30 determines whether or not the start code has been detected (operation 700) by referring to a variable found_sc_flag.

If the start code has been detected, the control unit 30 identifies the location of the packet corresponding to an entry point (operation 800).

FIG. 6 is a flowchart showing the operation 800 shown in FIG. 4.

The control unit 30 determines whether or not the value of overlapped_sc_flag is equal to binary “1” (operation 810); i.e., whether the start code is overlapped across at least two packets.

If the value of overlapped_sc_flag is equal to binary “1”, an entry point is identified by referring to the value of sc_tail_offset and the data length information of previous packets recorded on the packet information list as shown in FIG. 8 (operation 830).

The value of sc_tail_offset is set to “1” as a result of applying the operation 600 to the current input packet TP(N). The value of sc_tail_offset set to “1” indicates that the current input packet TP(N) contains one byte corresponding to the tail of the start code.

Since the start code has a length of four bytes in the present embodiment, a packet including a first byte of the start code is identified by referring to the packet information list which stores data length information of previous packets. Referring to the packet information list shown in FIG. 8, the transport packets TP(N-1) and TP(N-3) have a length of one byte, respectively, and thus correspond to the first and second bytes, respectively. Therefore, it can be considered that the head of the start code is contained in the transport packet TP(N-4) and thus the transport packet TP(N-4) is designated as an entry point.

On the other hand, if the value of overlapped_sc_flag is set to binary “0” as a result of determining the value of overlapped_sc_flag in the operation 810, it can be considered the current input packet TP(N) contains the entire start code. Therefore, the current input packet TP(N) is designated as an entry point (operation 830).

If the entry point is determined in the operation 800, the control unit 30 updates the packet information list and the entry point list stored in the packet information list storing unit 50 and the entry point list storing unit 70, respectively (operation 900).

FIG. 10 is a table showing the packet information list that has been updated. Comparing with FIG. 8 showing the packet information list that has not been updated, it is recognized that the length of the video data included in the current input packet TP(N) is increased.

FIG. 11 is a table showing the entry point list that has been updated. This shows that the packet TP(N-4) designated as the entry point in present embodiment is contained in the list as described above.

Meanwhile, if the start code has not been detected as a result of the operation 600 in which the start code detection is accomplished for the current input packet TP(N), operations 700 and 900 are performed, by-passing operation 800. Since the entry point has not been determined, only the packet information list is updated.

In the present embodiment, the method of detecting the start code and determining entry points has been described with respect to the video packets. However, the present invention is not limited by the video packets and can be adapted to a variety of technology fields that detect a predetermined start code from bit streams and designate the packet having the head of the start code as an entry point.

The invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can be distributed over network coupled computer systems so that the computer readable code is stored and executed in a distributed fashion.

According to the method of and the apparatus for determining entry points of the present invention, the locations of the data packets corresponding to entry points can be determined more easily. Also, unlike conventional devices and methods, a buffering memory is not needed to determine entry points. This enables the hardware to be constructed at a lower cost.

Although a few embodiments of the present invention have been shown and described, it would be appreciated by those skilled in the art that changes may be made in this embodiment without departing from the principles and spirit of the invention, the scope of which is defined in the claims and their equivalents.

1. A method of determining entry points, the method comprising:
shifting N bit data stored in an N bit shift register by n bits when n<N, incrementing a shift counter, and inputting an input data packet to the shift register by n bits;
determining whether the N bit data stored in the shift register corresponds with a predetermined start code;
identifying a data packet having a head of the predetermined start code by referring to the shift counter and/or a data packet information list that has been previously stored if the N bit data stored in the shift register is determined to correspond with the predetermined start code; and
designating the data packet having the head of the predetermined start code as an entry point, wherein the data packet information list contains data length information of each previous input data packet.

2. The method of claim 1, further comprising designating the input data packet as the data packet having the head of the predetermined start code if the shift counter is set to N/n.

3. The method claim 1, wherein identifying the data packet having the head of the predetermined start code comprises:
determining that the predetermined start code is overlapped across the input data packet and at least one previous input data packet if the shift counter is less than N/n; and
identifying the data packet having the head of the predetermined start code by referring to the shift counter and the data length information of each previous input data packet in the data packet information list.

4. The method according to claim 1, further comprising recording a location of the data packet designated as the entry point on an entry point list.

5. The method of claim 1, further comprising:
determining a data length of the input data packet;
extracting data from the input data packet if the data length is not zero; and
shifting the N bit data stored in the N bit shift register by n bits, incrementing the shift counter, and inputting the data extracted from the input data packet into the shift register by n bits.

6. The method of claim 5, further comprising updating the data packet information list by recording the data length of the input data packet on the data packet information list together with an index designating the input data packet.

7. The method according to claim 6, further comprising not updating the data packet information list when the data length of the input data packet is zero.

8. An apparatus for determining entry points, the apparatus comprising:
a shift register to store N bit data;
a data packet information list storing unit to store a data packet information list having data length information of each previous input data packet; and
a control unit to control operations of shifting N bit data stored in the shift register by n bits where n<N, incrementing a shift counter, inputting an input data packet into the shift register by n bits, identifying a data packet having a head of a predetermined start code by referring to the shift counter and/or the data packet information list stored in the data packet information list storing unit if the N bit data stored in the shift register corresponds with a predetermined start code, and designating the input data packet as an entry point.

9. The apparatus of claim 8, wherein the control unit designates the input data packet as the data packet having the head of the predetermined start code when the shift counter is set to N/n.

10. The apparatus of claim 8, wherein the control unit determines that the predetermined start code is overlapped across the input data packet and at least one previous input data packet when the shift counter is smaller than N/n, and identifies the data packet having the head of the predetermined start code by referring to the shift counter and the data length information of each previous input data packet in the data packet information list.

11. The apparatus of claim 8, further comprising an entry point list storing unit to store an entry point list having location information of a plurality of data packets corresponding to the entry points, the control unit updating the entry point list by recording the location information of the data packet designated as the entry point on the entry point list.

12. The apparatus of claim 8, further comprising a data extraction unit to extract data from the input data packet and provide the extracted data to the shift register, wherein the control unit detects a data length of the input data packet and outputs the data detection control signal to the data extraction unit if the data length is not zero.

13. The apparatus of claim 12, wherein the control unit updates the data packet information list by recording the data length of the input data packet on the data packet information list together with an index designating the input data packet.

14. The apparatus of claim 13, wherein the control unit does not update the data packet information list if the data length of the input data packet is zero.

15. A computer readable medium storing a program for implementing an entry point determination method, comprising:
shifting N bit data stored in an N bit shift register by n bits when n<N, incrementing a shift counter, and inputting an input data packet into the shift register by n bits;
determining whether the N bit data stored in the shift register corresponds with a predetermined start code;
identifying a data packet having a head of the predetermined start code according to the shift counter C and/or a data packet information list previously stored if the N bit data stored in the shift register corresponds with the predetermined start code; and
designating the data packet having the head of the predetermined start code as an entry point, wherein the data packet information list contains data length information of each previous input data packet.

16. An apparatus for determining entry points, the apparatus comprising:
a shift register storing data extracted from an input data packet;
a data packet information register storing data information relating to data previously stored in the shift register in order to identify a location of the data packet corresponding to one of the entry points; and
a control unit controlling the shift register to shift data stored in the shift register, identifying data having a head of a predetermined start code by referring to a shift counter of the shift register, and designating the identified data as the entry point if the data stored in the shift register corresponds with the predetermined start code;
wherein the apparatus does not comprise a buffer memory.

17. The apparatus of claim 16, wherein the control unit further identifies data containing the head of the predetermined start code by referring to the data information stored in the data packet information register.

18. The apparatus of claim 16, wherein data from the input data packet that is stored in the shift register is designated as the data having the head of the predetermined start code when a value of the shift counter is equal to the amount of data extracted from the input data packet.

19. The apparatus of claim 17, wherein the predetermined start code is overlapped across the input data packet and at least one previously inputted data packet when a value of the shift counter is less than the amount of data extracted from the input data packet, the control unit identifies the data packet having the head of the predetermined start code by referring to the data information of each previous input data packet stored in the data packet information register.

20. The apparatus of claim 16, further comprising an entry point list storing register having data information for a plurality of data packets corresponding to the entry point, the entry point list is updated with the data information of the data packet designated as the entry point.

21. The apparatus of claim 16, wherein the data information includes a data length amount, the data length amount does not include a packet header and a packetized elementary stream packet header.

22. The apparatus of claim 21, further comprising a data extraction unit to extract data from the input data packet and to provide the extracted data to the shift register, wherein the control unit detects the data length of the input data packet and controls the extraction of data if the data length is not zero.

23. The apparatus of claim 21, wherein the control unit updates the data packet information register by recording the data length of the input data packet and an index designating the input data packet.

24. The apparatus of claim 22, wherein the control unit does not update the data packet information register if the data length of the input data packet is zero.

25. The apparatus of claim 16, wherein the shift register stores an amount of data corresponding to the predetermined start sequence code, wherein a predetermined amount of the stored data is shifted in synchronization with a clock signal in order to accommodate the extracted data from the input data packet.

26. The apparatus of claim 16, wherein the data is video data.

27. A method of determining entry points, the method comprising:
shifting data stored in a shift register by a predetermined number of bits, incrementing a shift counter, and inputting data extracted from an input data packet to the shift register by the predetermined number of bits;
determining whether the data stored in the shift register corresponds with a predetermined start code;
identifying data having a head of the predetermined start code by referring to the shift counter when the data stored in the shift register corresponds with the predetermined start code, and
designating the identified data as one of the entry points.

28. The method of claim 27, further comprising storing data information in a data packet information register, the data information relating to data previously stored in the shift register.

29. The method of claim 28, further comprising designating the data extracted from the input data packet as the data having the head of the predetermined start code when a value of the shift counter is equal to the amount of data extracted from the input data packet.

30. The method of claim 29, further comprising identifying data containing the head of the predetermined start code by referring to data information stored in the data packet information register.

31. The method of claim 30, further comprising:
determining that the predetermined start code is overlapped across the input data packet and at least one previously inputted data packet when a value of the shift counter is less than the amount of data extracted from the input data packet; and
identifying the data packet having the head of the predetermined start code by referring to the data information of each previous input data packet stored.

32. The method of claim 29, further comprising recording a location of the data designated as the entry point on an entry point list.

33. The method of claim 32, further comprising updating the data packet information register and the entry point list after identifying the entry point.

34. The method of claim 33, wherein updating the data packet information register is accomplished by recording a data length of the input data packet and an index designating the input data packet.

35. The method of claim 34, wherein the data length is a number of data bytes of the input data packet less a packet header and a packetized elementary stream packet header.

36. The method of claim 29, further comprising:
extracting data from the input data packet if the data length is not zero;
supplying the shift register with the extracted data.

37. The method of claim 36, wherein the extracted data is sequentially provided to the shift register by a predetermined amount.

38. The method of claim 37, wherein the data stored in the shift register is left-shifted by a predetermined amount to accommodate the extracted data supplied to the shift register.

39. The method of claim 29, further comprising detecting a packet identification code included in a header of an input data packet to identify a type and a length of the data in the input data packet;

40. A computer readable medium storing a program for implementing an entry point determination method, comprising:
shifting data stored in a shift register by a predetermined amount when the predetermined amount is less than an available storage amount in the shift register, incrementing a shift counter, and inputting an input data packet into the shift register by the predetermined number of bits;
determining whether the data stored in the shift register corresponds with a predetermined start code;
identifying a data packet having a head of the predetermined start code according to the shift counter if the data stored in the shift register corresponds with the predetermined start code; and
designating the identified data packet as one of the entry points.

41. The computer readable medium of claim 40, further comprising storing data information in a data packet information register, the data information relating to data previously stored in the shift register.

42. The computer readable medium of claim 41, further comprising designating the data extracted from the input data packet as the data having the head of the predetermined start code when a value of the shift counter is equal to the amount of data extracted from the input data packet.

43. The computer readable medium of claim 42, further comprising identifying data containing the head of the predetermined start code by referring to the data information stored in the data packet information register.

44. The computer readable medium of claim 43, further comprising:
determining that the predetermined start code is overlapped across the input data packet and at least one previously inputted data packet when a value of the shift counter is less than the amount of data stored from the input data packet; and
identifying the data packet having the head of the predetermined start code by referring to the data information of each previous input data packet stored.

45. The computer readable medium of claim 42, further comprising recording a location of the data designated as the entry point on an entry point list.
